(19) United States
(12) Patent Application Publication
(10) Pub. No.: US 2025/0348494 A1
(43) Pub. Date: Nov. 13, 2025

(54) Data Transaction Management With Database On Edge Device

(71) Applicant: TESNOLOGY Inc., Tokyo (JP)

(72) Inventor: Katsuhiko Kondo, Tokyo (JP)

(73) Assignee: TESNOLOGY Inc., Tokyo (JP)

(21) Appl. No.: 18/704,289

(22) PCT Filed: Oct. 27, 2022
(86) PCT No.: PCT/JP2022/041100

§ 371 Date: Apr. 24, 2024

Related U.S. Application Data
(60) Provisional application No. 63/273,513, filed on Oct. 29, 2021.

(51) Int. Cl. G06F 16/2457; G06F 16/23; G06F 16/242; G06F 16/2458

(52) U.S. Cl. CPC G06F 16/2457; G06F 16/2379; G06F 16/243; G06F 16/2471

(57) ABSTRACT

Aspects of the disclosure provide for a computing device implementing a Digital Intelligence (DI) engine, for managing and querying a database of interrelated keywords obtained from data local to the computing device. The DI engine maintains a database of keywords parsed from various sources of data received by the computing device. The DI engine can generate weights to strengthen or weaken the association between keywords. When a query for a keyword is received, for example by another device implementing an instance of the DI engine, the computing device can receive the query, identify a keyword specified as part of the query, and send keywords associated with that specified keyword, as output. The DI engine can use the sent keywords to facilitate and manage transactions, including determining the cost-bearing party.

### BACKGROUND ART

### Background

Database management software is configured to manage a database, receive queries, and resolve queries by providing data from a database responsive to the query. Databases are often centralized at a common server, from which other computing devices can query the server through database management software to retrieve data. Some database management software can implement deep neural networks for analyzing data in the database. Databases are category centered. A category-centered database has a set of predetermined categories in a table of a database for storing data. Because the categories are predetermined, one issue with category-centered databases is handling highly diverse data, which may not fit into any predetermined category of the database.

### SUMMARY OF INVENTION

Database management software based on central databases is often unable to undergo major changes because the software is required to respond to the changing system demands. Therefore, existing user-facing systems, such as database management systems, are often slow to be updated, at least because of potential service interruption and user dissatisfaction. Further, changes to database management systems also are costly and time-consuming to perform.

### Solution to Problem

### BRIEF SUMMARY

Aspects of the disclosure provide for a computing device implementing a Digital Intelligence (DI) engine for managing and querying a database of interrelated keywords obtained from data local to the computing device. Rather than organize data by category, the DI engine maintains a database of keywords parsed from various sources of data received by the computing device. The DI engine can generate weights to strengthen or weaken the association between keywords. When a query for a keyword is received, for example, by another device implementing an instance of the DI engine, the computing device can receive the query, and return keywords associated with that specified keyword in the query, as output.

A system of devices implementing the DI engine may be configured to freely exchange data among one another without using a central intermediary, as described herein. Because the database is maintained locally on the computing device, the keywords in response to a query will vary from device to device. The keywords in response can be used to facilitate transactions of goods, services, or data between the computing devices, by providing an indication of the context in which users of the computing devices are communicating. The context can drive decisions for an automatic recommendation, what keywords to provide in response to a given query and to identify which party should bear the cost of the transaction. Aspects of the disclosure provide for a computing device. including: one or more processors configured to implement an instance of a digital intelligence (DI) engine, wherein in implementing the instance of the DI engine, the one or more processors are configured to: maintain a database local to the computing device, the database storing a plurality of keywords, each keyword associated with one or more other keywords according to a respective weight; receive a query specifying a keyword; and send, in response to the query, one or more keywords associated with the specified keyword.

Aspects of the disclosure provide for a system including: a first computing device implementing a first instance of a digital intelligence (DI) engine, and a second computing device implementing a second instance of the DI engine; and wherein the first computing device is configured to: maintain a database local to the computing device, the database storing a plurality of keywords, each keyword associated with one or more other keywords according to a respective weight; receive a query specifying a keyword; and send, in response to the query, one or more keywords associated with the specified keyword.

Aspects of the disclosure provide for a computer-implemented method including: maintaining, by one or more processors of a computing device configured to implement an instance of a digital intelligence (DI) engine, a database local to the computing device, the database storing a plurality of keywords, each keyword associated with one or more other keywords according to a respective weight; receiving, by the one or more processors, a query specifying a a first keyword; identifying, by the one or more processors, a second keyword stored in the database corresponding to the first keyword; and sending, by the one or more processors and in response to the query, one or more keywords associated with the second keyword.

Aspects of the disclosure can include one or more features, such as the feature described below. In some examples, aspects of the disclosure include some or all of the features, in combination.

The computing device is a first computing device; wherein the query is received from a second computing device implementing a second instance of the DI engine.

The computing device is a first computing device, and wherein the one or more processors are further configured to: monitor for queries from a second computing device implementing a second instance of the DI engine within a predetermined distance of the first computing device; and in response to the determination, receive the query from the second computing device.

In sending, in response to the query, the one or more keywords associated with the specified keyword, the one or more processors are configured to: receive a filter for filtering keywords and associated keywords, the filter based on the query; and filter keywords through the filter to obtain the one or more keywords.

The received query is part of a transaction between the first and the second computing device, the transaction characterizing the exchange of data including the one or more keywords sent by an instance of the DI engine in response to the received query, and wherein the one or more processors are further configured to determine a computing device to bear the cost of the transaction, based on the keyword specified in the query and one or more predetermined rules.

The second computing device is connected over a network to one or more other devices; and wherein the one or more processors are further configured to determine a value of the cost of a transaction based on the number of transactions between the first computing device and the one or more other devices via the second computing device.

The one or more processors are further configured to: receive, from one or more sensors of the computing device, input data as one or more of image data, audio data, and text; parse the input data to generate keywords; generate weights between keywords based at least on the frequency at which groups of two or more keywords appear within a predetermined proximity of one another; and update the database with the parsed keywords and generated weights.

In generating the weights between keywords, the one or more processors are further configured to generate the weights based on the frequency at which a given keyword is parsed from the input data.

In maintaining the database, the one or more processors are configured to: arrange the one or more other keywords for each keyword by frequency at which each of the one or more other keywords are parsed from the input data; and query the database in response to receiving the query, wherein in querying the database, the one or more processors are configured to retrieve the one or more other keywords for each keyword in order of frequency.

The computing device is a first computing device, and wherein the one or more processors of the first computing device are further configured to: receive, from a second computing device implementing a second instance of the DI engine, the query; receive, from the second computing device, one or more keywords and the respective weight for each of the one or more keywords for the specified keyword in a database maintained by one or more processors of the second computing device; and update the database local to the first computing device, with the one or more keywords received from the second computing device.

### BRIEF DESCRIPTION OF DRAWINGS

FIG. 1 is a block diagram of a transaction monitoring system implemented for monitoring transactions between a first computing device and one or more other terminals.

FIG. 2 is a block diagram of a transaction monitoring system implementing a DI engine.

FIG. 3A shows an example keyword dictionary in a database for a DI engine.

FIG. 3B shows an example combined dictionary 350.

FIG. 4 shows a hierarchical relationship of a keyword dictionary based on the frequency of use of different keywords.

FIG. 5 is a flowchart of an example process for processing a query by a DI engine.

FIG. 6 is a flowchart of an example process for performing a transaction between instances of DI engines.

FIG. 7 is a flowchart of an example process for performing a transaction and exchanging information of a user of a device implementing a DI engine.

FIG. 8 is a flowchart of an example process of data filtering using a keyword dictionary of a DI engine.

FIG. 9 is a flowchart of an example process of generating a recommendation for a course of action by a DI engine, based on historical data and current data in conjunction with the keyword dictionary of the DI engine.

### DESCRIPTION OF EMBODIMENTS

### Detailed Description

### Overview

Aspects of the disclosure provide for a computing device implementing a Digital Intelligence (DI) engine for managing and querying a database of interrelated keywords obtained from data local to the computing device. Rather than starting with a predetermined set of categories or categories, the DI engine is configured to parse keywords, for example, names, phone numbers, addresses, and keywords describing products, businesses, or locations, from various sources of data. Then, the DI engine generates associations, quantified as weights, between the parsed keywords, or between the parsed keywords and other keywords currently stored in the database.

The DI engine can receive a query specifying a keyword. The DI engine is configured to respond to the query with one or more keywords associated with the specified keyword. Because the DI engine maintains data local to the computing device implementing the engine, the response to the query can vary from implementation to implementation. For example, if a keyword can refer to both a common household item and a popular retail store, the keyword will have a stronger association to one of the two, depending on, for example, the frequency at which the DI engine has detected the keywords used together.

A “keyword” is a natural language (e.g., Japanese, English, etc.) word or phrase identified by the DI engine. A keyword can be identified by the DI engine through text, such as text communications on a device implementing the DI engine. A keyword can be identified as words or phrases imaged by sensors on a device implementing the DI engine (such as a roadside sign captured using a camera). A keyword can also be identified through recording and processing audible speech within the sensor range of the DI engine.

A “category” is a label applied by the DI engine to a target keyword. A category may be itself a keyword associated with the target keyword. For each keyword associated with the target keyword, the DI engine can quantify the strength of the association between the keyword and the target keyword. The strength of the association is a numerical value and represents a prediction by the DI engine of how likely the use of a keyword in the context of a spoken or written communication is in reference to a category.

The DI engine maintains a database that is keyword-centered, not category-centered. The DI engine, as described herein, manages a database that parallels a more naturally intelligent keyword-centered organization. Rather than start with predetermined categories for organizing keywords that may not capture all types of data that can be stored in a database, the DI engine associates keywords together and assigns a keyword as a category based on a current situation or context in which the DI engine is operated.

The DI engine can be implemented as a respective instance across each of multiple computing devices configured to communicate with one another. By implementing the DI engine as multiple instances locally, instead of through a centralized platform, the DI engine can scale and more effectively manage individual user data through the use of local databases.

An instance of the DI engine can provide data local to the keyword dictionary, for example, to another instance of the DI engine on another device.

The DI engine can provide a number of different applications, generally centered around extending the keyword-centered mode of natural intelligence to aid a user in content recommendation and performing various transactions for goods, services, and data. For example, the DI engine can receive a query for a keyword. The specified keyword in the query is associated with one or more other keywords, which can be provided in response to the query. For example, a transaction may be the purchase of a product or service, or the transfer of information corresponding to a user or device of the system. A transaction monitoring system implementing the DI engine, as described herein, may determine which party to bill for using the system. For instance, the transaction monitoring system may charge a usage fee for using the network to perform the transaction. System usage fees may be charged on a per-use basis. The system determines the device of a party to be billed, for example, according to a transaction type from one device to another. In some examples, the transaction monitoring system can manage transactions in which the device of one party is charged for the receipt of personal data from another party.

As another example, consider two computing devices, a cell phone of a restaurant goer, and a server for a restaurant. Both devices can implement an instance of the DI engine. When the restaurant goer goes to the restaurant, the server-DI engine can query the user for “dietary preferences” or “dietary restrictions.” The cell phone-DI engine can response one or more keywords associated with the queried keyword, for example “liver” or “fish” in response to a query for “dietary restrictions.” The cell phone-DI engine can optionally filter the result data, according to a user-defined filter, as described herein. The server-DI engine can then provide a menu, with the dietary restrictions specified by the cell phone-DI engine removed.

As another example, an air conditioner unit (A/C unit) can implement the DI engine through a microcontroller connected to the unit. When a DI engine for a first device is detected, the A/C unit-DI engine can query the device-DI engine for “temperature preference.” The device-DI engine can specify a temperature preference as a keyword associated with the specified keyword of the query, such as “21 degrees Celsius.” The A/C unit can then adjust the temperature to the preferred temperature.

As another example, the DI engine can be implemented as part of a transaction monitoring system, as described herein. The transaction monitoring system can support the exchange of funds, for example digital currency, fiat currency, or points or other indicators of value within a real or virtual economy. The transaction monitoring system can apply a set of predetermined rules for determining which party should bear the cost, such as a system usage fee, for the transaction between two devices with instances of the DI engine. For example, in the example between the restaurant server DI-engine and the restaurant goer cell phone-DI engine, the restaurant server-DI engine may be predetermined to bear the cost of the transaction.

While the vendor or server-provider may be the party bearing the cost for a transaction, there may also be exceptions to the rules, supported by data received from a DI engine of a party's device. For example, while a vendor may ordinarily bear the cost of a transaction for a good or service, the DI engine of a customer may be queried as to the desired item and return an item that is of limited availability. In that case, the transaction monitoring system may trigger an exception to cause the customer to bear the cost of the transaction, and not the vendor.

Aspects of the disclosure can provide for a number of technical advantages. The DI engine provides for locally managed data that does not require a central database for facilitating transactions.

The DI engine can be implemented on any of a variety of computing devices, including resource-constrained devices, such as devices with limited memory and compute power. The DI engine can be implemented on resource-constrained devices, and also take advantage of continuing improvements in certain technologies, such as database management, to maintain and retrieve data from a local database maintained for each instance of the DI engine.

In addition, the DI engine can be implemented without cost-prohibitive training and model architectures found in other approaches, such as in deep learning. The DI engine can implement a set of rules for determining the strength of an association between keywords, which is interpretable versus analyzing a black box machine learning model to ascertain the relationship between inputs and outputs.

The DI engine as described herein is energy-efficient, at least due to its low cost of implementation querying data as described herein. In addition to low operational costs, the DI engine also has low communications costs between devices also implementing the DI engine. To that end, networks or other communication mediums that are low-power or rated for high-efficiency can be used to communicate between the devices, as opposed to complex connections between a client device and a central server.

DI engine also allows for full control of user data, by allowing the user of a device implementing the DI engine to control how and when user data is provided. The DI engine allows, for example, keeping collected data private, and providing collected data only to other computing devices according to user-determined filters. The DI engine can store timestamp information and decoded data related to transactions and exchanges of data between a computing device implementing the DI engine and other devices. The data exchanged can also be encrypted using any of a variety of encryption protocols between the communicating devices implementing respective instances of the DI engine.

Unlike a centrally managed database, the DI engine does not have to be reconfigured with new categories in response to new types of data. Individual instances of the DI engine can manage user-specific data, making the DI engine easier to update and manage versus central database management systems responsible for managing all user data. The DI engine can be implemented on any of a variety of different computing architectures and devices, including von Neumann (or Princeton) architectures.

Aspects of the disclosure provide for a system in which the computing devices of the relevant parties perform the transaction, with the cost assigned to one or both of the parties. By performing the transactions across the computing devices of the parties, the need for a central system is eliminated. Instead, individual devices operated by parties to the transaction can perform the operations of the transaction.

### Example Systems

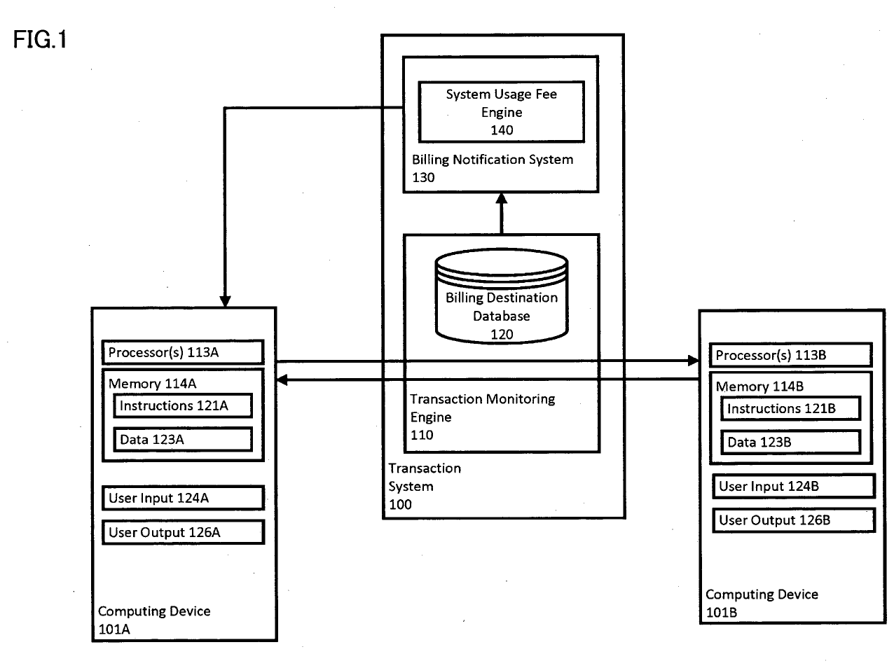

FIG. 1 is a block diagram of a transaction system 100 implemented for monitoring transactions between a first computing device 101A and a second computing device 101B. The transaction system 100 can be implemented on one or both of the first computing device and the second computing device 101B. The transaction system 100 includes a transaction monitoring engine 110 with a billing destination database 120, as well as a billing notification system 130 with system usage fee engine 140.

A computing device can implement a transaction system, for example the computing device 101A and the computing device 101B, and can either be the sender or recipient of data in a given transaction. The system 100 can apply a set of rules for determining the cost bearer. An example rule can be that, between the devices of a customer and a retail store, the transaction monitoring system will cause the device of the retail store to bear the cost of the transaction. There also may be exceptions to the rules. For example, the transaction monitoring system may cause the device of the customer to bear the cost of the transaction when the transaction relates to products or services of limited availability. The rules can be implemented as part of the transaction monitoring engine 110.

The billing destination database 120 can store data defining the billing destination for each transaction. The destination can be based on a data type for the transaction. For example, certain requests for data may cause the computing device 101A to bear the cost of the transaction, while other requests may cause the computing device 101B to bear the cost, instead.

The system 100 can determine what rules to apply based on information provided between the computing devices 101A-B, which may be generated by an instance of a DI engine, as described herein. For example, one rule may be that when the transaction is for ordering a limited sale item by a requesting computing device 101A of, for example, a user,) to the computing device 101B of, for example, a retail store, the user-computing device bears the cost of the transaction. As another example, a rule may be that when the shop-computing device receives a request for a transaction of a good or service currently undergoing a stock clearance sale, then the shop-computing device bears the cost of the transaction. As another example, if the user-computing device is requesting to purchase tickets within a limited time before the respective event, then the user-computing device may be required to bear the cost.

Other rules may specify that the shop (or vendor) in the above examples bears the cost of the transaction. For example, if the shop-computing device for information about the user, such as their shopping preferences, then the shop-computing device bears the cost of the transaction.

The transaction monitoring engine 110 can also maintain a database of billing destinations to track transactions managed by the system 100, including parties to the transaction, the nature of the transaction, and the amount charged per transaction. The transaction monitoring engine 110 can store the number of times one computing device accessed the other computing device, for example through a query for data.

Upon determining a recipient according to the predetermined rules, the transaction monitoring engine 110 can forward the designation to the billing notification system 130. The billing notification system can use the system usage fee engine 140 to determine the cost for a party to the transaction designated as the bearer of the cost. Information transmitted between the computing devices 101A-B can include headers indicating the destination of transactions for internal processing within the system 100.

The value of the system usage fee engine 140 can vary. The system usage fee engine 140 can be configured to calculate billing based on the number of transactions between the computing devices 101A-B. In some examples, the system usage fee engine 140 can apply a discount based on the volume of transactions, depending on the number of times one computing device accessed the other. In some examples, the system usage fee engine 140 can also calculate the cost based on the amount of data transferred between devices. The amount of data may be measured in megabytes, gigabytes, or other such data measurements.

In some examples, the system is implemented in front of an internal server of a network. Billing for transactions can be managed based on the number of server accesses from within the company through one or more employee computing devices, for example. The system 100 allows for the linking of data for processing. Although many employees already have a core system in place, most of them are still managing their own data using file management and other systems.

This is because companies have introduced systems for each business unit, and digital data is not connected, so each employee needs to connect and manage the data by themselves. Digital data collection systems are mainly based on databases, and it is difficult to connect digital data between business units, so in most cases employees manage their own data using word processing or other programs. In order to solve this problem, it is possible to start from the end by connecting data in an edge-type distributed system based on the data of each employee.

In some examples, the billing notification system 130 can bill to the computing device 101A (or 101B) in batches, or per transaction.

Each computing device manages its own wallet, and the transaction system keeps track of who is exchanging charges with whom, verifying that the billing process is done correctly and that it has not been tampered with.

The computing devices 101A, B (collectively, computing devices 101) can include a number of components, including one or more processors 113A-B (collectively, processor(s) 113), memory 114A-B (collectively, memory 114), instructions 121A-B (collectively, instructions 121), data 123A-B (collectively, data 123), user input 124A-B (collectively, user input 124), and user output 126A-B (collectively, user output 126).

Computing devices 101 can be communicatively coupled over a network. Memory 114 can include any type of non-transitory computer readable medium capable of storing information, such as a hard-drive, solid state drive, tape drive, optical storage, memory card, ROM, RAM, DVD, CD-ROM, write-capable, and read-only memories.

Computing devices 101 can include one or more processors 113 and memory 114. The memory 114 can store information accessible by the processor(s) 113, including instructions 121 that can be executed by the processor(s) 113. The memory 114 can also include data 123 that can be retrieved, manipulated, or stored by the processor(s) 113. The memory 114 can be a type of non-transitory computer readable medium capable of storing information accessible by the processor(s) 113, such as volatile and non-volatile memory. The processor(s) 113 can include one or more central processing units (CPUs), graphic processing units (GPUs), field-programmable gate arrays (FPGAs), and/or application-specific integrated circuits (ASICs), such as tensor processing units (TPUs). Example processing units also include ARM, x86, and x64-based processors, single-board computers (SBCs); microcontrollers; system-on-a-chip (SoC), etc.

The instructions 121 can include one or more instructions that when executed by the processor(s) 113, causes the one or more processors to perform actions defined by the instructions. The instructions 121 can be stored in object code format for direct processing by the processor(s) 113, or in other formats including interpretable scripts or collections of independent source code modules that are interpreted on demand or compiled in advance. The system 400 can be executed using the processor(s) 113, and/or using other processors remotely located from the server computing device 115.

The data 123 can be retrieved, stored, or modified by the processor(s) 113 in accordance with the instructions 121. The data 123 can be stored in computer registers, in a relational or non-relational database as a table having a plurality of different fields and records, or as JSON, YAML, proto, or XML documents. The data 123 can also be formatted in a computer-readable format such as, but not limited to, binary values, ASCII, or Unicode. Moreover, the data 123 can include information sufficient to identify relevant information, such as numbers, descriptive text, proprietary codes, pointers, references to data stored in other memories, including other network locations, or information that is used by a function to calculate relevant data.

The computing devices 101 can also include a user output 126, and a user input 124. The user input 124 can include any appropriate mechanism or technique for receiving input from a user, such as keyboard, mouse, mechanical actuators, soft actuators, touchscreens, microphones, and sensors.

The computing devices 101 can be configured to display at least a portion of the received data on a display implemented as part of the user output 126. The user output 126 can also be used for displaying an interface between the computing devices 101. The user output 126 can alternatively or additionally include one or more speakers, transducers or other audio outputs, a haptic interface or other tactile feedback that provides non-visual and non-audible information to the platform user of the user computing device 112.

Although FIG. 1 illustrates the processors 113 and the memories 114 as being within the computing devices 101, components described in this specification, including the processors 113 and the memories 114 can include multiple processors and memories that can operate in different physical locations and not within the same computing device. For example, some of the instructions 121 and the data 123 can be stored on a removable SD card and others within a read-only computer chip. Some or all of the instructions and data can be stored in a location physically remote from, yet still accessible by, the processors 113. Similarly, the processors 113 can include a collection of processors that can perform concurrent and/or sequential operation. The computing devices 101 can each include one or more internal clocks providing timing information, which can be used for time measurement for operations and programs run by the computing devices 101.

The computing devices 101 can be capable of direct and indirect communication over the network. The computing devices 101 can set up listening sockets that may accept an initiating connection for sending and receiving information. The network itself can include various configurations and protocols including the Internet, World Wide Web, intranets, virtual private networks, wide area networks, local networks, and private networks using communication protocols proprietary to one or more companies. The network can support a variety of short- and long-range connections. The short- and long-range connections may be made over different bandwidths, such as 2.402 GHz to 2.480 GHz (commonly associated with the Bluetooth® standard), 2.4 GHz and 5 GHz (commonly associated with the Wi-Fi® communication protocol); or with a variety of communication standards, such as the LTE® standard for wireless broadband communication. The network, in addition or alternatively, can also support wired connections between the computing devices 101, including over various types of Ethernet connection.

It is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

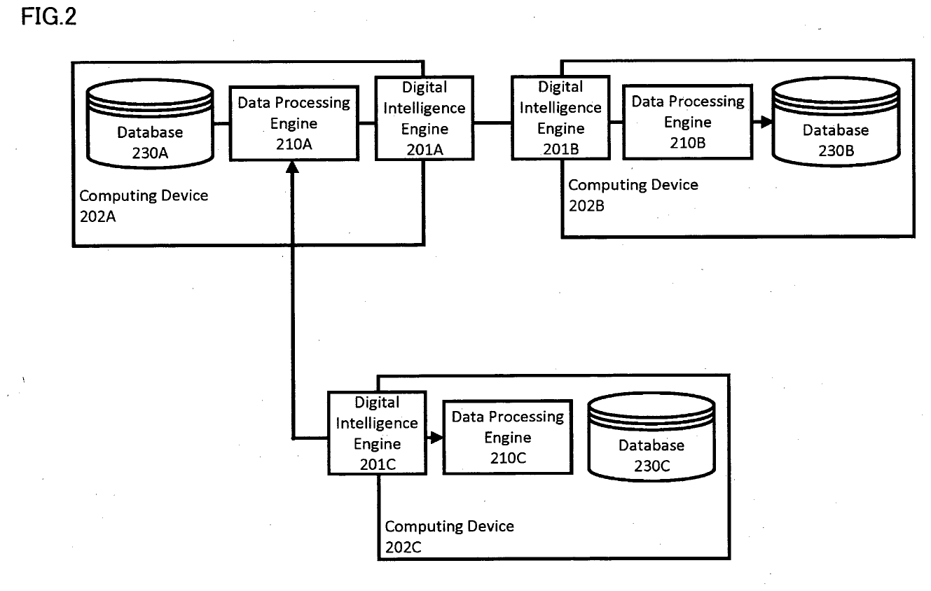

FIG. 2 is a block diagram of computing devices 201A-C implementing DI engines 200A-C. Each computing device 202A-C includes a DI engine 201A-C, a data processing engine 210A-C, and a database 230A-C.

In addition to the computing devices described herein, computing devices implementing instances of the DI engine can include or be connected to various sensors, home appliances, locks, delivery boxes, digital devices as a means of communication with them, smart phones, smart watches, etc., and will be able to connect and manage digital data freely while ensuring its confidentiality.

Data transferred by the transaction monitoring system can be processed by the data intelligence (“DI”) engine according to aspects of the disclosure. The DI engine is configured to receive data local to a respective computing device and process the data to identify one or more keywords. The DI engine can provide data regarding those associations to other devices with instances of the DI engine. Each device can also include a respective instance of the transaction monitoring system, configured to assess the cost and device of the party bearing the cost in transferring DI engine-generated data to another device.

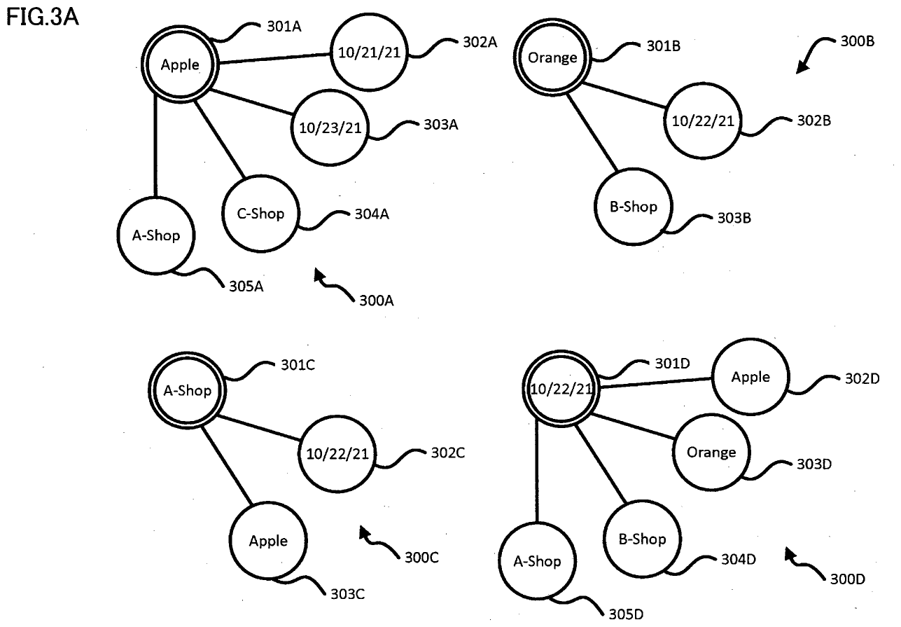

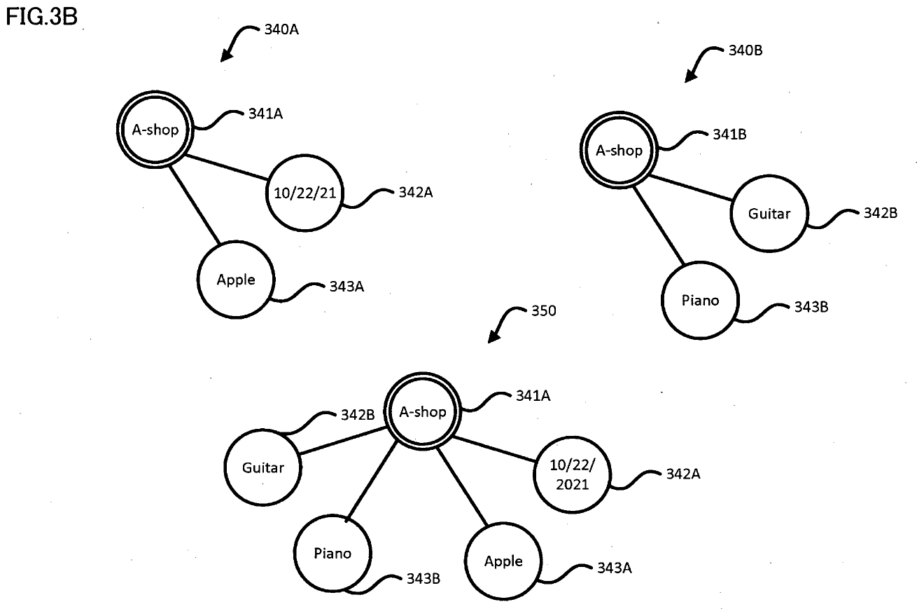

Upon detecting keywords used, the DI engine can query a database local to the computing device. The database can store keyword dictionaries, for example as shown herein with reference to FIGS. 3A-B. The keyword dictionary is a data structure that stores data for mapping one or more keywords encountered by the DI engine, with corresponding one or more other keywords. The DI engine can represent stronger or weaker associations between a given keyword and its associated other keywords, to better represent the context in which a certain keyword is applied.

The DI engine can receive input data through user input of the computing device. For example, the DI engine may receive as audio input a statement, such as “I bought an apple at the A-store.” From the input, the DI engine can parse the audio for keywords, for example “apple” and “A-store.” The DI engine can generate an association between the two keywords, with a weight value representing that the two keywords are related. The DI engine can continuously receive input data, for example as audio, image, and/or text data. After parsing the input data for keywords, the DI engine can add additional associations with keywords, or if the keywords already exist in the database, increase corresponding weights to adjust the strength of the association.

In FIG. 2, the computing devices 200A-C can send queries and receive data responsive to the queries, for example as one or more keywords. The computing device 202A can send data to the computing device 202B. The computing devices can implement, as part of the data processing engine, the transaction system as described herein with reference to FIG. 1. The computing device 202A can also communicate with the computing device 202C, and two devices 200B and 200C can determine the bearer of the cost of the transaction using the data processing engine 210B or the data processing engine 210C.

Consent as between the computing devices to communicate with one another can be obtained in advance, for example, by enabling a user preference on an interface for the DI engines 201A-C.

FIG. 3A shows example keyword dictionaries 300A-D in a database for a DI engine. Each dictionary is represented as a graph of nodes from a grouping 301A-D to other nodes. The nodes are connected by a link, each link having a respective weight generated by the DI engine. TABLE 1, below, shows keywords shown in the dictionaries 300A-D:

TABLE 1

| | Fruits | Date | Shop |
|---|---|---|---|
| 1 | Apple | Oct. 22, 2021 | A-shop |
| 2 | Orange | Oct. 22, 2021 | B-shop |
| 3 | Apple | Oct. 23, 2021 | C-shop |

For example, when the keyword “apple” is queried as shown by double-circled node 301A, the associated keywords by the keyword “apple” include the date 10/21/21 in node 302A, the date 10/23/21 in node 303A, the keyword “C-Shop” in node 304A, and the keyword in node 305A.

As another example, when the keyword “Orange” is queried as shown by double-circled node 301B, the associated keywords by the keyword “Orange” include the data 10/22/21 in node 302B, and the keyword B-Shop in node 303B.

As another example, when the keyword “A-Shop” is queried as shown by double-circled node 301C, the associated keywords by the keyword “A-Shop” include the data 10/22/21 in node 302C and the keyword “Apple” in node 303C.

As another example, when the keyword “10/22/21” is queried as shown by double-circled node 301D, the associated keywords by the keyword “10/22/21” include the keyword “Apple” in node 302D, the keyword “Orange” in node 303D, the keyword “B-Shop” in node 304D, and the keyword “A-shop” in node 305D.

FIG. 3B shows an example combined dictionary 350. A combined dictionary can be combined from separate keyword dictionaries of different instances of the DI engine. TABLE 2 shows keywords for a different DI engine than a DI engine with the keywords as in TABLE 1.

TABLE 2

| | Shop | Musical Instrument |
|---|---|---|
| 1 | A-shop | Guitar |
| 2 | B-shop | Piano |
| 3 | C-shop | Trumpet |

The combined dictionary 350 is combined from dictionary 340A from the first DI engine and TABLE 1, and dictionary 340B from the second DI engine and TABLE 2. The combined dictionary 350 can be added to either one or both of the databases of the first and second DI engines, to enhance the databases with additional associations between keywords not collected from a single DI engine, alone.

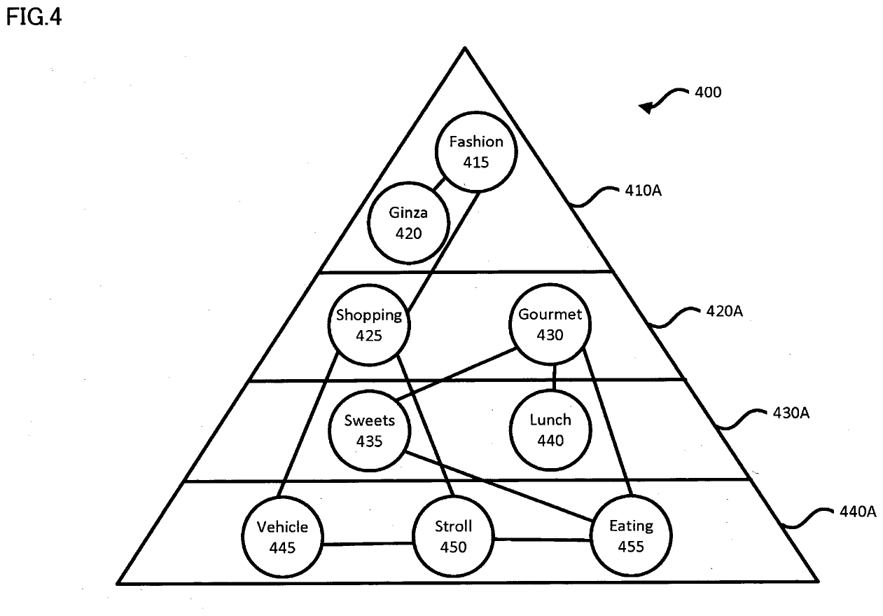

FIG. 4 shows a hierarchical relationship 400 of a keyword dictionary based on frequency of use of different keywords 415-455.

A keyword dictionary is created and placed within the database. In order to speed up queries, they are expanded and combined within the stored memory. As described below, sequential hierarchization according to the “keywords to be focused on” speeds up the search process (detection of words that are highly related to keywords). In addition to frequency of keywords, the DI engine also processes each keyword to identify frequency of keywords used together, for example, in a conversation recorded by the DI engine. The position of a keyword in the hierarchy of frequency of the database can therefore also be based on the frequency with which it appears with other keywords at the same level.

The DI engine can further prioritize various keywords in the keyword dictionary according to the frequency of observation. For example, if a certain keyword, such as the name of a popular retail store, is commonly observed, then the DI engine can rearrange the order in which keyword mappings are stored to allow queries to the popular retail store to be resolved faster. For example, the keyword dictionary can be hierarchical, with higher levels corresponding to more frequently observed keywords, and lower levels corresponding to less frequently queried keywords.

Hierarchy is determined by frequency of appearance. The database contains keywords that are related to each other. The keywords are hierarchized according to the “keywords to be focused on,” for example keywords specified in queries, with associated keywords with stronger association appearing at the top. Likewise, it becomes easy to detect which are highly relevant keywords. In this example, the hierarchy includes four levels 410A-440A. Keywords higher in the hierarchy, for example keyword 415, 420 are more frequently observed by the DI engine, versus those keywords lower in the hierarchy, for example keywords 445-455.

### Example Methods

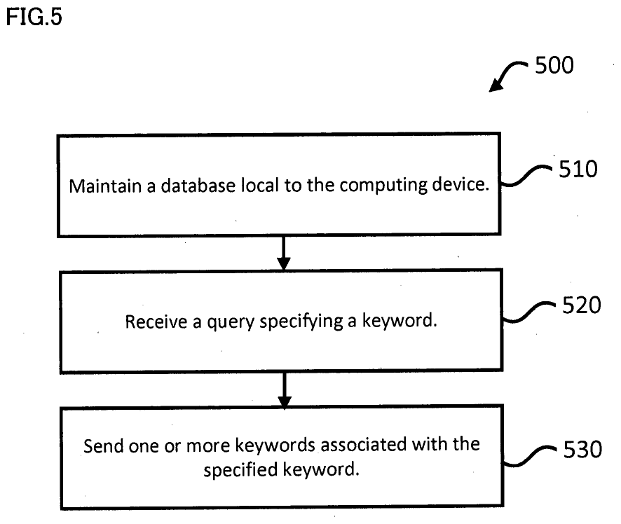

FIG. 5 is a flowchart of an example process for processing a query by a DI engine.

The DI engine maintains a database local to the computing device, according to block 510. The database can store keywords, each keyword associated with one or more other keywords according to a respective weight. The database can include keyword dictionaries generated by the DI engine, as described herein.

The DI engine receives a query specifying a keyword, according to block 520.

The DI engine sends one or more keywords associated with the specified keyword, according to block 530. The DI engine can retrieve keywords with stronger associations with the identified keyword first, in some examples. Further, the DI engine can store keywords in the database to retrieve more frequently observed keywords before less frequently observed keywords.

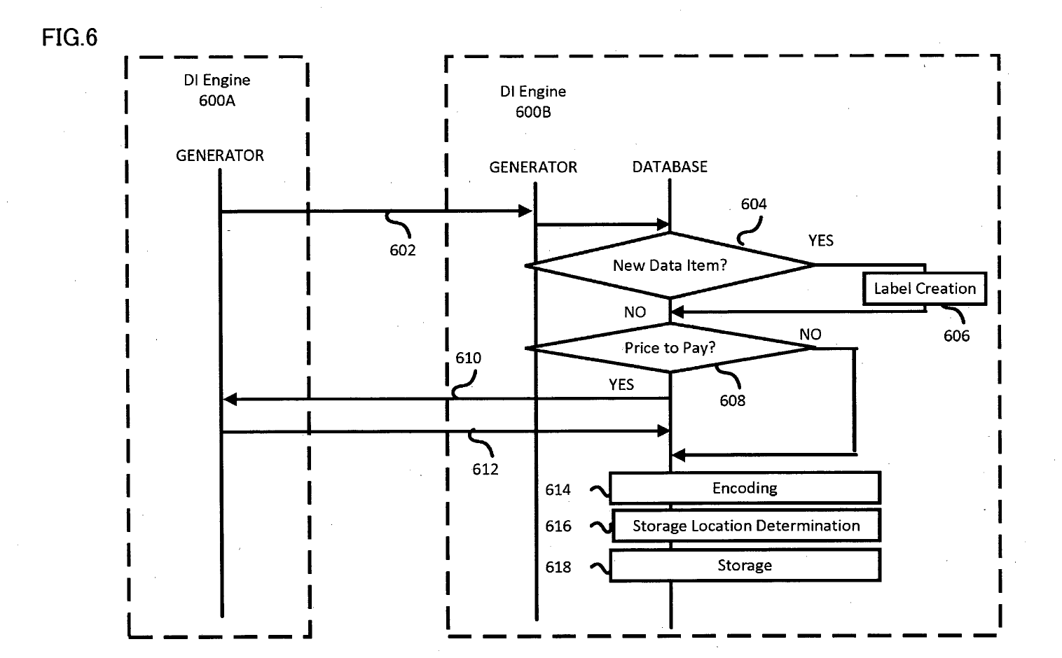

FIG. 6 is flowchart of an example process 600 for performing a transaction between instances of DI engines. In this example process 600,

The DI engine 600A sends data to the DI engine 600B, according to line 602. The DI engine 600B determines whether the data is new, according to diamond 604. If the data is new (“YES”), then the DI engine 600B adds the data to its database, according to block 606. In any case (“YES” or “NO”), the DI engine 600B determines whether the computing device of the DI engine 600A needs to bear the cost of the transaction. If so (“YES”), the DI engine 600B requests payment from the DI engine 600A, and receives payment in kind, according to lines 610 and 612, respectively. Afterwards, the DI engine 600B encodes the data, determines a location to store the data, and finally stores the data, according to blocks 614, 616, and 618, respectively. As part of storing the data, the DI engine 600B encrypts the data according to a key private to the DI engine 600B.

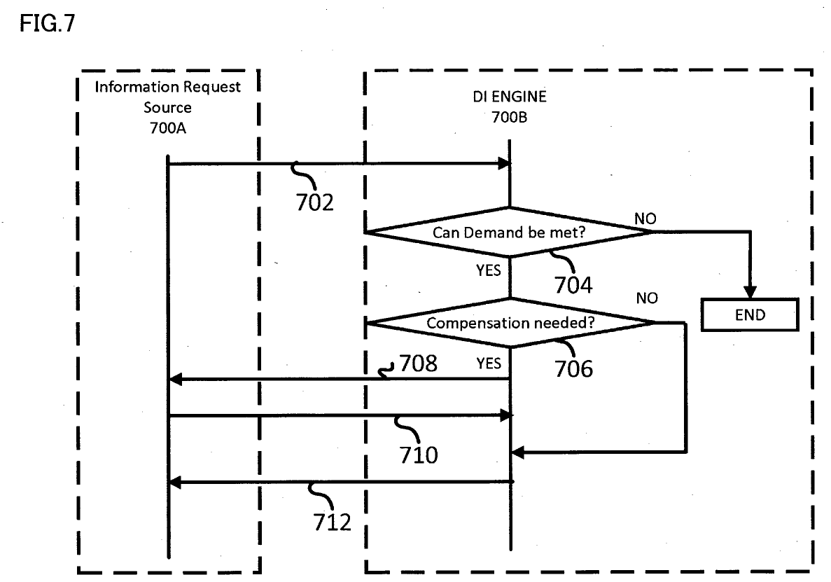

FIG. 7 is a flowchart of an example process 700 for performing a transaction for information of a user of a device implementing a DI engine. An information request source 700A can be another DI engine, or other type of computing device configured to request information from a DI engine 700B.

Personal management of data is not centralized, but rather managed by users of respective instances of the DI engine. If personal information for a user is to be obtained, it may require compensation, depending on user preferences.

The information request source 700A sends a request for information to the DI engine 700B, according to line 702. The DI engine 700B determines whether the request can be met, according to block 704. For example, the DI engine 700B determines whether the requested information is available, and whether the DI engine 700B has permission to share the information.

If so (“YES”), the DI engine 700B determines whether compensation is necessary, according to diamond 706. Otherwise (“NO”) the process 700 ends.

If the DI engine 700B determines that compensation is not necessary (“NO”), the DI engine 700B provides the requested information, according to line 712. Otherwise (“YES”), the DI engine 700B requests payment or compensation, according to line 708. The Information request source 700A provides compensation for the transaction, according to block 710.

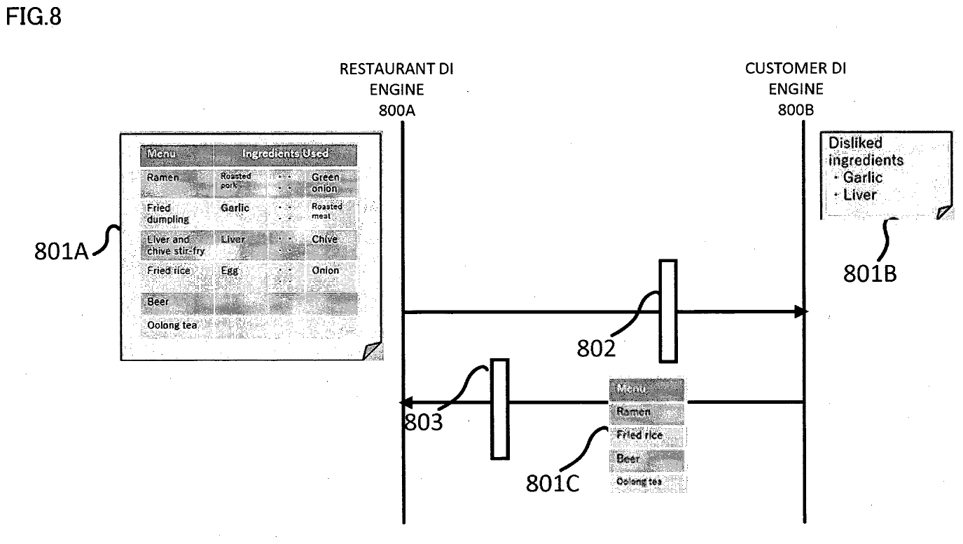

FIG. 8 is a flowchart of an example process of data filtering using a keyword dictionary of a DI engine. As described herein, a data filter can be generated to filter out certain data before the data is provided. In addition to filtering out potentially sensitive or confidential data, a filter can reduce the amount of data for processing between DI engines during a transaction. The filters can be defined by a user of a computing device implementing a DI engine.

Filter data can be specified by a user using an interface of the DI engine. The interface can be text-based or multi-modal, for example using speech or gestures. In other examples, the interface is a graphical user interface displayed on the display of a computing device connected to a DI engine. For example, a user can register “disliked ingredients” as a keyword for generating a corresponding filter, described presently.

For example, a first instance of a DI engine on a mobile device of a customer may provide information filtered according to dietary restrictions, to a second instance of the DI engine of a restaurant. The filter can be used to filter what data is provided by the DI engine generating the filter, and/or to filter what data is provided by the DI engine in response to a query for data.

A restaurant DI engine 800A, for example on a computing device associated with a restaurant, maintains a database 801A including a menu of available items for sale. The available items for sale are associated with their ingredients. The customer DI engine 800B, for example on a mobile device of a customer to the restaurant, also stores a database 801B including a “disliked ingredients” keyword associated with “liver” and “garlic.”

Once within proximity of the DI engine 800A, the DI engine 800B can automatically send a query requesting a menu from the restaurant DI engine 800A.

The customer DI engine 800B provides a filter 802 to the restaurant DI engine 800A. The filter 802 indicates that “garlic” and “liver” are associated with “disliked ingredients.” As part of providing the data, the restaurant DI engine 800A can pass the data through a filter, based on the context of the transaction between the two DI engine instances.

The restaurant DI engine 800A receives the filter, and applies the filter in providing its own data, for example a menu with items removed according to the provided dietary restrictions. The filter 803 can include the filter 802, in addition to other items that may be filtered. For example, the filter 803 may also exclude menu items that are not currently available.

The restaurant DI engine 800A provides a menu 801C, including data filtered according to the filter 803. In effect, the computing device for the DI engine 800B receives a menu tailored to the user, providing menu items while excluding a user's disliked ingredients.

The restaurant then receives the filter data, filters the menu prepared by the restaurant, and shows the user a menu that excludes dishes that should not be presented to the user.

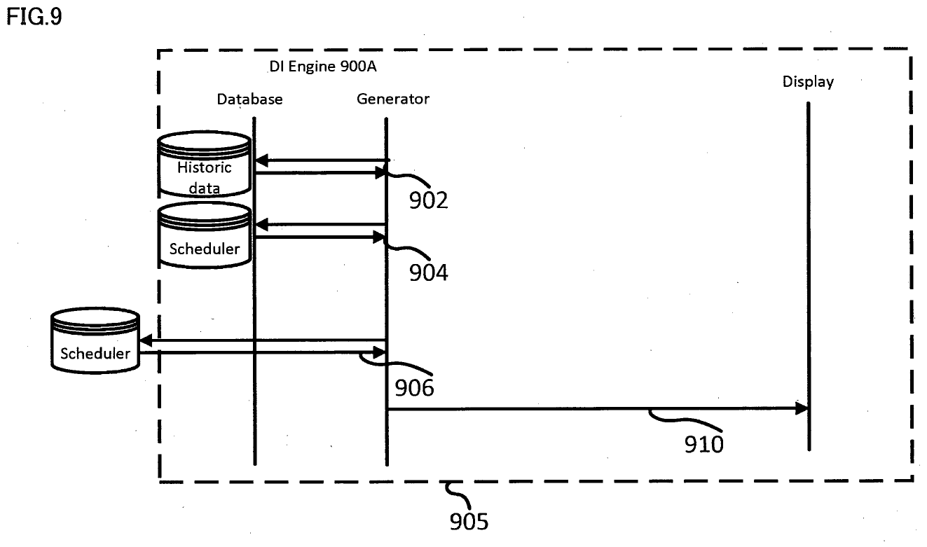

FIG. 9 is a flowchart of an example process of generating a recommendation for a course of action by a DI engine, based on historical data and current data, in conjunction with the keyword dictionary of the DI engine. The DI engine can access other sources of data, in addition to input data from different sensors as described herein. For example, the DI engine can access a network to obtain specific kinds of information, such as traffic information. The DI engine can maintain historical data, which can include data describing prior events for the user of a computing device implementing the DI engine. The DI engine can also access schedule data for the user of the computing device implementing the DI engine. Using a combination of different sources of data, the DI engine can function as, for example, a concierge or digital assistant for a user.

In FIG. 9, a DI engine 900 of a mobile device 905 can receive historical data, according to line 910. The historical data can be, for example, that the user of the mobile device 905 picks up and drops her child at cram school every Thursday. The historical data can also indicate that the user leaves home at 18:30 on Thursdays.

The DI engine 900 can receive schedule data, according to line 904. For example, the DI engine 900 can use the schedule data to determine that today is Thursday and cram school begins soon.

The DI engine can receive traffic data, according to line 906. The DI engine can determine from the traffic data that there is a considerable amount of traffic.

With the received information, the DI engine can generate a recommendation to the user to leave at 18:15, and not at 18:30, due to the traffic, according to line 910.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification, the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as” “such as”,” “including” and the like, should not be interpreted as limiting the subject matter of the claims to the specific examples; rather, the examples are intended to illustrate only one of many possible implementations. Further, the same reference numbers in different drawings can identify the same or similar elements.

With respect to the use of substantially any plural and/or singular terms herein, for example (with the term “element” being a stand-in for any system, component, data, etc.) “an/the element,” “one or more elements,” “multiple elements,” a “plurality of elements,” “at least one element,” etc., those having skill in the art can translate from the plural to the singular and/or from the singular to the plural as is appropriate to the context and/or application described. The various singular/plural permutations may be expressly set forth herein, for sake of clarity and without limitation unless expressly indicated.

1. A computing device comprising:
one or more processors configured to implement an instance of a digital intelligence (DI) engine, wherein in implementing the instance of the DI engine, the one or more processors are configured to:
maintain a database local to the computing device, the database storing a plurality of keywords, each keyword associated with one or more other keywords according to a respective weight;
receive a query specifying a keyword; and
send, in response to the query, one or more keywords associated with the specified keyword.

2. The computing device of claim 1,
wherein the computing device is a first computing device; and
wherein the query is received from a second computing device implementing a second instance of the DI engine.

3. The computing device of claim 1,
wherein the computing device is a first computing device, and
wherein the one or more processors are further configured to:
monitor for queries from a second computing device implementing a second instance of the DI engine within a predetermined distance of the first computing device; and
in response to the determination, receive the query from the second computing device.

4. The computing device of claim 3,
wherein in sending, in response to the query, the one or more keywords associated with the specified keyword, the one or more processors are configured to:
receive a filter for filtering keywords and associated keywords, the filter based on the query; and
filter keywords through the filter to obtain the one or more keywords.

5. The computing device of claim 4,
wherein the received query is part of a transaction between the first and the second computing device, the transaction characterizing the exchange of data comprising the one or more keywords sent by an instance of the DI engine in response to the received query, and
wherein the one or more processors are further configured to determine a computing device to bear the cost of the transaction, based on the keyword specified in the query and one or more predetermined rules.

6. The computing device of claim 5,
wherein the second computing device is connected over a network to one or more other devices; and
wherein the one or more processors are further configured to determine a value of the cost of a transaction based on the number of transactions between the first computing device and the one or more other devices via the second computing device.

7. The computing device of claim 1, wherein the one or more processors are further configured to:
receive, from one or more sensors of the computing device, input data as one or more of image data, audio data, and text;
parse the input data to generate keywords;
generate weights between keywords based at least on the frequency at which groups of two or more keywords appear within a predetermined proximity of one another; and
update the database with the parsed keywords and generated weights.

8. The computing device of claim 7, wherein in generating the weights between keywords, the one or more processors are further configured to generate the weights based on the frequency at which a given keyword is parsed from the input data.

9. The computing device of claim 1, wherein in maintaining the database, the one or more processors are configured to:
arrange the one or more other keywords for each keyword by frequency at which each of the one or more other keywords are parsed from the input data; and
query the database in response to receiving the query, wherein in querying the database, the one or more processors are configured to retrieve the one or more other keywords for each keyword in order of frequency.

10. The computing device of claim 1,
wherein the computing device is a first computing device, and
wherein the one or more processors are further configured to:
receive, from a second computing device implementing a second instance of the DI engine, the query;
receive, from the second computing device, one or more keywords and the respective weight for each of the one or more keywords for the specified keyword in a database maintained by one or more processors of the second computing device; and
update the database local to the first computing device, with the one or more keywords received from the second computing device.

11. A system comprising:
a first computing device implementing a first instance of a digital intelligence (DI) engine, and
a second computing device implementing a second instance of the DI engine; and
wherein the first computing device is configured to:
maintain a database local to the computing device, the database storing a plurality of keywords, each keyword associated with one or more other keywords according to a respective weight;
receive a query specifying a keyword; and
send, in response to the query, one or more keywords associated with the specified keyword.

12. The system of claim 11,
wherein the query is received from the second computing device.

13. The system of claim 11,
wherein the first computing device is further configured to:
monitor for queries from the second computing device implementing a second instance of the DI engine within a predetermined distance of the first computing device; and
in response to the determination, receive the query from the second computing device.

14. The system of claim 13,
wherein in sending, in response to the query, the one or more keywords associated with the specified keyword, the first computing device is configured to:
receive a filter for filtering keywords and associated keywords, the filter based on the query; and
filter keywords through the filter to obtain the one or more keywords.

15. The system of claim 14,
wherein the received query is part of a transaction between the first and the second computing device, the transaction characterizing the exchange of data comprising the one or more keywords sent by an instance of the DI engine in response to the received query, and
wherein the first computing device is further configured to determine a computing device from one of the first and second computing device to bear the cost of the transaction, based on the keyword specified in the query and one or more predetermined rules.

16. The system of claim 15,
wherein the second computing device is connected over a network to one or more other devices; and
wherein the first computing device is further configured to determine a value of the cost of a transaction based on the number of transactions between the first computing device and the one or more other devices via the second computing device.

17. The system of claim 11, wherein the first computing device is further configured to:
receive, from one or more sensors of the computing device, input data as one or more of image data, audio data, and text;
parse the input data to generate keywords;
generate weights between keywords based at least on the frequency at which groups of two or more keywords appear within a predetermined proximity of one another; and
update the database with the parsed keywords and generated weights.

18. The system of claim 17, wherein in generating the weights between keywords, the first computing device is further configured to generate the weights based on the frequency at which a given keyword is parsed from the input data.

19. The system of claim 11, wherein in maintaining the database, the first computing device is configured to:
arrange the one or more other keywords for each keyword by frequency at which each of the one or more other keywords are parsed from the input data; and
query the database in response to receiving the query, wherein in querying the database, the first computing device is configured to retrieve the one or more other keywords for each keyword in order of frequency.

20. A computer-implemented method comprising:
maintaining, by one or more processors of a computing device configured to implement an instance of a digital intelligence (DI) engine, a database local to the computing device, the database storing a plurality of keywords, each keyword associated with one or more other keywords according to a respective weight;
receiving, by the one or more processors, a query specifying a first keyword;
identifying, by the one or more processors, a second keyword stored in the database corresponding to the first keyword; and
sending, by the one or more processors and in response to the query, one or more keywords associated with the second keyword.
